(19) United States
(12) Patent Application Publication
(10) Pub. No.: US 2004/0231131 A1
(43) Pub. Date: Nov. 25, 2004

(54) Method for inserting a workpiece into another and device therefor

(76) Inventors: Jean-Louis Daulon, Castres (FR); Dominique Maynadier, Lacrouzette (FR)

Correspondence Address: Pendorf & Cutliff, 5111 MFemorial Highway, Tampa, FL, 33634-7356, US

(21) Appl. No.: 10/492,142

(22) PCT Filed: Oct. 9, 2002
(86) PCT No.: PCT/FR02/03440

(30) Foreign Application Priority Data
Oct. 10, 2001 (FR) 01/13033

(51) Int. Cl. B23Q 3/00; B23P 19/02

(52) U.S. Cl. 29/464; 29/525; 29/898.07

(57) ABSTRACT

The invention concerns a method for inserting a so-called inserted workpiece (100) into a receiving workpiece (200) comprising a reception zone (210) therefor by means of a machine-tool whereon is installed an inserting device (D) including receiving means and positioning means (420). The invention is characterized in that it consists in causing the end of the inserting device (D) to penetrate into the reception zone (210) and urged to be supported on the receiving workpiece (200) so as to form a vise whereof the actuation of the jaws formed by the support point (410) on said receiving workpiece (200) and by the receiving means and positioning means (420) of the insertion workpiece (100), brings the insertion workpiece (100), installed on the inserting device (D), towards the reception zone (210) of said receiving workpiece (200) and inserts it therein. The invention also concerns the device for implementing said method. The invention is useful for inserting workpieces from a machine-tool.

### AREA OF APPLICATION OF THE INVENTION

The present invention is concerned with the field of machining, specifically with adaptation permitting the performance of the operation of insertion of workpieces to the inside of the workpiece to be machined, under better conditions, during its machining phases.

### DESCRIPTION OF THE PRIOR ART

In the manufacturing phases of certain automobile workpieces, it happens that the insertion operation of workpieces inside the workpiece to be machined must be performed during the machining phases of the said workpiece.

This is the case for machining transmissions, which requires the insertion of guide bearings or guide rings, which are themselves machined once they are inserted into the workpiece.

In order to diminish the time of manufacture, as well as the defects of repositioning due to a machine change for realizing this insertion operation, which constitutes an operation different from a machining operation, the designers of machine tools devised fitting devices that permit exploitation of the movement capabilities of the machine tools for machining for realizing the actual fitting operation.

Due to the fitting device which has the classical catching devices of a tool, the machine tool ensures the following:

taking up the insertion workpiece present on a mounting provided for this purpose,

insertion of it into the workpiece that has just been machined, then

after changing the tool, continuation of the machining process of the workpiece to be machined.

This insertion operation by the machine tool for machining nevertheless suffers from numerous constraints and disadvantages, the principal ones of which are cited below.

Since the insertion has to be performed according to a tight adjustment, a large force is required for the realization of this operation. Now, this momentum or force is not always available on the axis of the machine tool, which was not designed for such operations.

Moreover, if this force is available, sometimes, during the insertion movement, the workpiece to be machined or the insertion workpiece is damaged without finding this out, until the end of the manufacturing process.

As a matter of fact, with the existing fitting devices, it is difficult to control the position of the insertion workpiece into the workpiece to be machined and the same is true for controlling of the force used for this insertion.

Machine tools for machining that have the force necessary for this insertion have not been designed for such operations. Also, their constituting elements and, notably, the guide elements and entrainment elements necessary for performing the movement along the axis of the insertion may become damaged or become worn prematurely, with all the consequences that this may have with regard to the precision of the machine tool.

These disadvantages become more critical when the entrainment movements of the mobile elements of the machine tool are operated using linear motors, which cannot provide the required force. The adaptation of a classical fitting device to such a machine tool would demand over-dimensioning of the linear motorization with the consequences both on space requirement as well as on cost and machine performance.

### DESCRIPTION OF THE INVENTION

Starting from this state of affairs, the Applicant carried out research aimed at alleviating the disadvantages cited above and conceiving a method of insertion of a workpiece into another that could economize on the means of entrainment and guidance of the machine tool, while maintaining the qualities of the machine.

Another objective of the invention is to permit machine tools with linear motors to perform such operations.

Another objective of the invention is to permit better control of the insertion operation both at the level of positioning the inserted workpiece or the insertion workpiece or of the force taken up by the machine tool.

These investigations led to the realization of a particularly advantageous method of insertion that can be used with any type of machine tool.

According to the invention, the method of insertion of an insertion workpiece into a receiving workpiece, having a reception zone provided for this purpose, with the aid of a machine tool onto which an insertion device of the type having a receiving means and a positioning means for the insertion workpiece are installed, characterized by the fact that it consists of penetrating at least the end of the insertion device into the reception zone and to make it supported on the said receiving workpiece, so as to form a vice, the jaws of which are put into motion by the supporting point on the receiving workpiece on the one hand and by the receiving means and positioning means of the insertion workpiece on the other hand, bringing the insertion workpiece, present on the insertion device, toward the reception zone of the receiving workpiece and performing its insertion inside the latter.

This characteristic is particularly advantageous in that it permits to economize in the entrainment elements and guide elements of the machine tool by transmitting the force of putting into motion and insertion into the receiving workpiece by supporting on the latter. The force is thus contained and localized between the two jaws of the vice.

Consequently, to the extent that the putting in motion no longer depends on the available power in the machine tool, it is no longer necessary to over-dimension the entrainment elements of the latter. Similarly, by making the machining functions independent of those of insertion, the method of the invention can be adapted onto any type of machine tool.

The force is thus concentrated on the workpiece itself and it is particularly well-distributed by utilization of the principle of the vice. Consequently, neither the receiving workpiece nor the insertion workpiece are subjected to pressing-type forces, to which the workpieces are subjected when the methods of the prior art are used.

This method of the invention is adapted and optimized in the case where the machine tool is a machine tool with linear motors or others on the axis of insertion of the workpiece. As a matter of fact, according to a particularly advantageous characteristic, the insertion method is characterized by the fact that it consists in freeing the corresponding motorization at the axis of insertion, so that putting the insertion device in motion, by its resting on the workpiece to be machined, causes a relative movement between the insertion workpiece and the receiving workpiece, without the means of putting into motion on this axis intervening or becoming an obstacle.

This characteristic is made possible by the possibilities of motors which, similarly to linear motors, have their primary and secondary blocks free of movement relative to one another when they are not fed. Thus, within the non-limiting framework of a machine tool for machining of the type that puts into motion a coupling ring on three axes using linear motors, the insertion operation being realized parallel to the Z axis, by supporting on the receiving workpiece, the method of the invention allows liberation of the entrainment organs on the Z axis, the coupling ring becoming free in translation on this axis, a freedom which can be exploited for the insertion movement, which will bring the coupling ring toward the receiving workpiece.

Another object of the invention resides in that the device permits the use of such a method. According to the invention, this insertion device, made of one insertion workpiece into a receiving workpiece, being adapted to a machine tool, is characterized by the fact that it consists of at least one means of support on the receiving workpiece, a supporting and positioning means of the insertion workpiece, and a kinematic module ensuring the separation or approach between the support means and the receiving means, the putting in motion of the said kinematic module being ensured by an independent means of producing motion.

The utilization of an independent means for putting in motion permits economizing on the means of entrainment and guidance of the machine tool, notably by being supported on the receiving workpiece. Similarly, containment of the forces to the inside of the device of the invention provides a particularly advantageous characteristic of the invention, namely that the force exerted and the courses realized by the kinematic module are measured.

This kinematic module may be realized according to several modes of realization which will be described below.

As a matter of fact, the fundamental concepts of the invention having been exposed above in their most elementary form, other details and characteristics will follow more clearly upon reading the Description which follows, and related to the attached drawings, giving several embodiments of a method of insertion and of a device permitting its use according to the invention, given as non-limiting examples.

### BRIEF DESCRIPTION OF THE DRAWINGS

FIG. 1 is a schematic cross-sectional view of a first embodiment of the insertion device according to the invention.

FIG. 2 is a schematic cross-sectional view of a second embodiment of the insertion device according to the invention.

FIGS. 3a, 3b and 3c are schematic cross-sectional views of a device of the invention with the receiving workpiece and the insertable workpiece illustrating the phases of operation of the device according to the invention.

### DESCRIPTION OF PREFERRED EMBODIMENTS

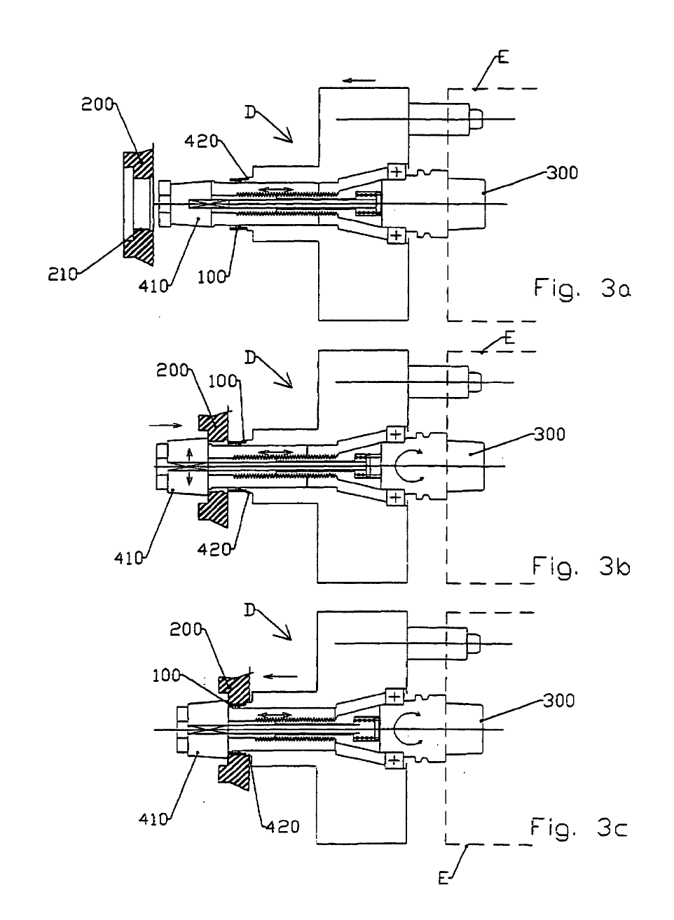

The drawings in FIGS. 3a, 3b, and 3c illustrate the insertion operation of a guide ring referenced with 100 constituting the insertion workpiece inside a workpiece to be machined, which constitutes the receiving workpiece 200 in which a boring or reception zone 210 will be made, which will receive the said guide ring/insertable workpiece 100 by fitting.

According to the invention, the method of insertion is characterized by the fact that device D, or alternatively, insertion device D, ensures the following operations once the end of the insertion device D has been introduced into the reception zone 210 formed:

deployment of at least one supporting point (FIG. 3b),

its approach toward a support zone of the receiving workpiece 200,

support on the support zone of the receiving workpiece 200,

the approach by relative movement of the insertion workpiece 100 toward the reception zone 210 made in receiving workpiece 200 (FIG. 3c),

the insertion operation.

This method can be carried out by a plurality of devices to two preferred but non-limiting embodiments of which will be described below.

In general and according to the invention, this device D is adaptable to a machine tool which could be any kind of tool. For this purpose, device D has at one of its ends a standard catching means 300, or alternatively catching organ, which can be placed, for example, at the end of an electro, electronic, or electric spindle E partially illustrated with a line of short dashes. This adaptability is particularly advantageous since the storage and utilization of a device does not require particular adaptation of the part of the machine tool.

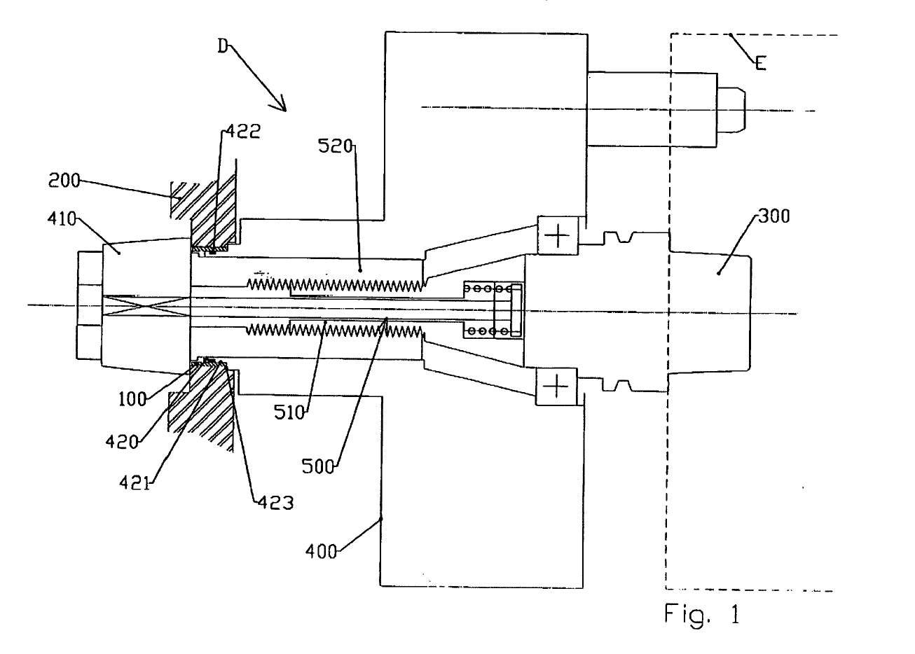

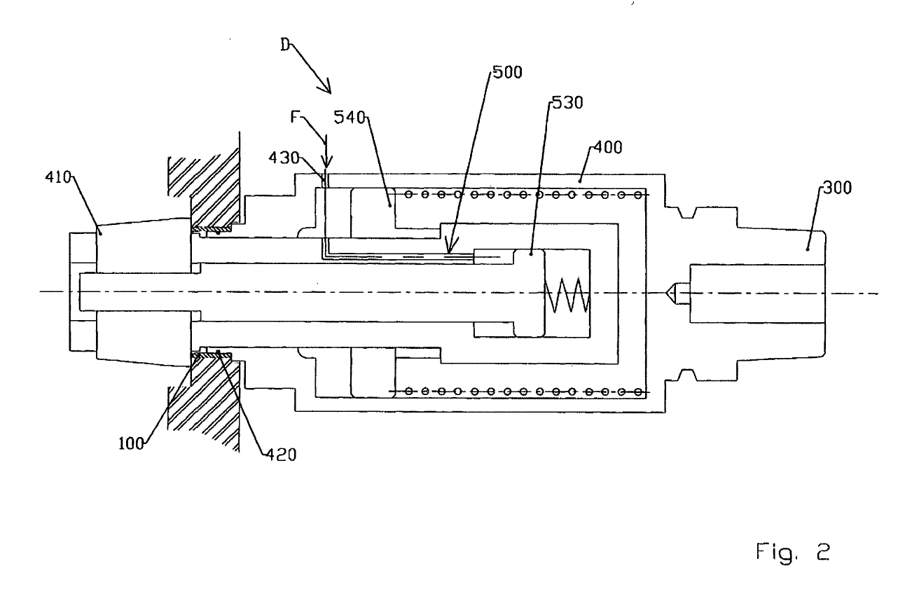

As illustrated in the drawings of FIGS. 1 and 2, this device D consists of a body 400 having a support means or supporting point 410 on which the receiving workpiece 200, a receiving means and positioning means 420 of the insertion workpiece 100, and a kinematic module 500 ensuring the separation or approach between the supporting means 410 and the receiving means and positioning means 420, the means of putting the said kinematic module into movement being independent. According to the embodiment illustrated, the receiving means and positioning means 420 of the insertion workpiece 100 is constituted here by a cylindrical part 421 preformed from a groove in which a joint 422 is located that ensures maintenance of the said ring 100 in position when the latter is inserted on the cylindrical part 421. The positioning itself is ensured by a shoulder 423 adjacent to the said cylindrical part 421. Together with the supporting point or points 410, this shoulder 423 constitutes the jaws of the vice formed by device D of the invention.

Based on these statements, the drawing of FIG. 3a shows device D facing the boring/reception zone 210 made in the receiving workpiece 200 in order that the ring 100 be inserted in it. The supporting points 410 are retracted. The end of device D is then introduced into boring/reception zone 210.

The drawing of FIG. 3b illustrates the device D, the supporting points 410 of which, once deployed, will be supported on receiving workpiece 200.

The drawing in FIG. 3c illustrates device D, the supporting points 410 and the receiving means and positioning means 420 of which are made to approach to be inserted inside bore/reception zone 210 of ring 100.

The embodiment illustrated in the drawing of FIG. 1 is particularly suitable for an application in which the machine tool has a means of moving the tool of the type of an electric spindle E tool holder. As a matter of fact, according to a particularly advantageous characteristic of the invention, the means of independent setting in motion consists of the motor of the electro spindle E, that is, by the electro spindle itself. Thus, according to the invention, it is not the motorization intended to put in movement either the workpiece or the coupling ring that is used, but that intended for the rotation of the electric spindle E of the machine tool. This solution is especially advantageous in an application on a machine with linear motors, the motors of which are not liable to provide, under good conditions, the force required for insertion of a ring inside a boring.

According to the invention and as illustrated in the figures, the device D has at its other end at least one retractable supporting point 410, constituting the said means of support, which, retracted so as to be able to penetrate into the reception zone of the receiving workpiece 200, that is, into the boring/reception zone 210, is deployed during the beginning of the movement of the said kinematic module 500, thus ensuring a supporting point by direct contact or by means of an intermediate device on the receiving workpiece 200. According to the embodiments illustrated in FIGS. 1 and 2, the device D has two supporting points 410.

According to the particularly advantageous embodiment illustrated in FIG. 1, the kinematic module 510 consists of a helicoidal joint transforming the rotation of the electric spindle E into a translational movement, which, on the one hand, ensures deployment and retraction of the supporting point 410 at the end of device D, and, on the other hand, the approach or separation of the supporting point 410 and of the receiving means and positioning means 420 of the insertion workpiece 100. More precisely, the catching organ 300 entrains a threaded rod 510 into rotation, which is in helicoidal connection with a shuttle 520, of which only the translational movement along the rotational axis of a threaded rod 510 is allowed to remain free. The first effect of this translational movement is to deploy the supporting points 410 at the end of device D at the middle of inclined planes and then to make the distance between the supporting points 410 and the receiving means and positioning means 420 of ring 100 diminish progressively, while the ring remains fixed. Thus, the supporting points will then be supported against the receiving workpiece 200. Once the device D is supported on receiving workpiece 200, the continuation of the internal translational movement of the shuttle 520 causes to put in motion the system, which supports device D or that ensuring the support of receiving workpiece 200, so as to ensure the actual insertion phase.

As a matter of fact, utilization of device D of the invention should not be limited to machine tools with a ring which is mobile along 3 axes, but can also be very well adapted to machine tools where the subassembly supporting the receiving workpiece 200 to be machined is mobile.

When this machine tool is equipped with linear motors, these latter are shut off on the axis of insertion, so that only the motor for electric spindle E provides force and puts the kinematic module 500 in motion. The utilization of a helicoidal joint exhibits here all its advantages by reduction of the speed and thus increases of the available force as a function of the thread.

When the machine tool is equipped with another type of motorization that cannot be released, the motors will play an accompanying role during the approach of the jaws of the vice formed by the device D of the invention.

Another advantage of the utilization of a helicoidal joint resides in the ability to digitize the forces and the course formed by knowing the position of the supporting points on the receiving workpiece 200 and that of the insertion workpiece 100 in the receiving and positioning means. This characteristic is thus particularly advantageous in that it permits envisaging quality control of the insertion operation, notably by ensuring that the force necessary for insertion is within a certain interval. As a matter of fact, too smooth an adjustment and thus too low force or a too tight adjustment and thus a very large force would be the consequence of a poor boring, of a poor ring or of poor positioning of the ring on the receiving and positioning means.

After the phase illustrated by FIG. 3c, that is, once the insertion has been performed, the electric spindle E performs a rotation in the opposite direction, the translational movement of which is associated here, first of all, separates the receiving means and positioning means 420 from the supporting point(s) 410 and then, next, it retracts the supporting points in order to allow disengagement of device D from boring/reception zone 210 equipped with ring 100.

According to the embodiment illustrated in FIG. 2, the means of putting the kinematic module 500 in motion consists of a feed illustrated by arrow F, in a fluid used by the machine tool. This fluid could consist of the cutting oil classically used by machine tools for machining.

As illustrated, the kinematic module 500 consists of a combination of pistons which ensure, on the one hand the deployment and retraction of the supporting point 410 at the end of device D and, on the other hand, the approach or separation of the supporting point 410 and the receiving means and positioning means 420 of the insertion workpiece 100. The use of a hydraulic solution for putting the kinematic module into movement is particularly advantageous in that it permits avoidance of the elements necessary for the transformation of the rotational movement into a translational movement, which should prevent the rotation of certain parts of device D as well as avoid the disadvantages inherent in all mechanical solutions. According to this embodiment, the measurement of the force is performed by one or several manometers.

More precisely, when the fluid is introduced through orifice 430 into the inside of body 400 of device D, a first piston 530 is activated in its translational movement, ensuring deployment of the supporting points 410. Once the supporting points 410 were deployed, the pressure of the fluid is distributed over a second piston 540, the translation of which ensures first of all placement of supporting points 410 on the receiving workpiece 200 and then, secondly, according to the invention, the approach of the jaws of the vice formed by supporting points 410 and by the receiving means and positioning means 420. The supporting points being blocked in translation by the receiving workpiece 200, the insertion workpiece 100 is fitted into bore/reception zone 210 of receiving workpiece 200. The release of pressure permits the return means in position such as springs to resume their initial position at pistons 530 and 540, so as to unlock the vice and to retract the supporting points 410.

It is understood that the method of insertion and the device permitting performing it, which were described and represented above, were done more in view of divulging rather than a limitation. Naturally, various changes, modifications and improvements can be applied to the examples cited above without departing from the framework of the invention, as defined in the claims.

Thus, for example, it is not necessary for the supporting points 410, defined by device D to be in direct contact with receiving workpiece 200. As a matter of fact, the main function of the latter is to ensure a supporting point for putting either the insertion workpiece into movement toward the receiving piece or the receiving piece toward the insertion workpiece. Thus, any intermediate means could be intercalated between the supporting points 410 and the receiving workpiece 200.

1-10. (cancelled).

11. A method of inserting an insertion workpiece (100) into a receiving workpiece (200), wherein the receiving workpiece (200) has a reception zone (210), wherein the insertion workpiece (100) is inserted into the receiving workpiece (200) by a machine tool on which an insertion device (D) is installed, and wherein the machine tool comprises a receiving and positioning means (420) of the insertion workpiece (100), comprising:
penetrating at least one end of the insertion device (D) into the reception zone (210),
supporting said receiving workpiece (200) with said insertion device (D), so as to form a vice which consists of a supporting point (410) on the receiving workpiece (200) and the receiving and positioning means (420) of the insertion workpiece (100),
moving the vice to bring the insertion workpiece (100) of the insertion device (D) toward the reception zone (210) of the receiving workpiece (200), and
inserting the insertion workpiece (100) into the inside of the receiving workpiece (200).

12. The method according to claim 11, wherein once the introduction of the end of the insertion device (D) into the reception zone (210) is performed, the device (D) ensures the following operations:
deploying at least one supporting point (410),
approaching the supporting zone of the receiving workpiece (200),
supporting on the supporting zone of the receiving workpiece (200),
approaching due to relative movement of the insertion workpiece (100) to the reception zone (210), arranged in the receiving workpiece (200), and
the insertion operation.

13. The method according to claim 11, of the type adopting an insertion device (D) adapted to a machine tool having linear motors or others, wherein it consists in freeing the corresponding motorization at the axis of insertion so that when the insertion device (D) is put into motion, this causes, by its being supported on the receiving workpiece (200), the relative movement between the insertion workpiece (100) and the receiving workpiece (200).

14. An insertion device (D) of an insertion workpiece (100) into a receiving workpiece (200) arranged on a machine tool permitting performance of the method according to claim 11, wherein said insertion device (D) consists of at least one supporting means (410) on the receiving workpiece (200), a receiving and positioning means (420) of the insertion workpiece (100) and a kinematic module (500) ensuring the separation or approach between the supporting means (410) and the receiving means (420), the putting of said kinematic module (500) into motion being ensured by an independent means of putting into motion.

15. The device (D) according to claim 14, in which the machine tool has an electric spindle motor (E) as the independent means of putting into.

16. The device (D) according to claim 14, further comprising at least one retractable supporting point constituting the said supporting means, which, retracted so as to be able to penetrate into the reception zone of the receiving workpiece (200), is deployed during the beginning of the setting in motion of the said kinematic module (500), thus ensuring a supporting point on the receiving workpiece (200).

17. The device according to claim 14, wherein the kinematic module (500) is constituted by a helicoidal joint transforming rotation of the means of setting in motion into a translational movement, which ensures the deployment and retraction of the supporting point (410) at the end of the device (D) and also ensures the approach or separation of the supporting point (410) and of the receiving and positioning means (420) of the insertion workpiece (100).

18. The device (D) according to claim 14, wherein the means of setting the kinematic module (500) in motion is constituted by a fluid feed (arrow F) used by the machine tool.

19. The device (D) according to claims 14, wherein the kinematic module (500) is constituted by a combination of pistons, which ensure the deployment and the retraction of the supporting point (410) at the end of the device (D) and the approach or separation of the supporting point (410) and of the receiving and positioning means (420) of the insertion workpiece (100).

20. The device (D) according to claim 14, wherein force exerted and courses realized by the kinematic module (500) are measured.
